(19) United States
(12) Patent Application Publication
(10) Pub. No.: US 2008/0185323 A1
(43) Pub. Date: Aug. 7, 2008

(54) Water Treatment System

(75) Inventor: John Harold Kargenian, Buffalo Grove, IL (US)

Correspondence Address: MAYER BROWN LLP, P.O. BOX 2828, CHICAGO, IL, 60690, US

(73) Assignee: AWTP, LLC., Elk Grove Village, IL (US)

(21) Appl. No.: 11/672,179

(22) Filed: Feb. 7, 2007

(51) Int. Cl. C02F 1/44; B01D 29/88

(52) U.S. Cl. 210/117; 210/133; 210/251; 210/435; 210/437

(57) ABSTRACT

A water treatment system for removing impurities from incoming feed water includes a manifold having a plurality of water treatment filter housings connected thereto. The filter housings are configured to accept a plurality of water treatment filter cartridges, which have, at one end, a filter housing cap fixedly attached thereto. The system manifold is also adaptable to be able to connect to peripheral accessories, filtration devices, and identical water treatment systems.

### FIELD OF THE INVENTION

This disclosure relates to water treatment systems. Additionally, this disclosure relates to an apparatus for performing water filtration purification, and more specifically, reverse osmosis water filtration purification.

### BACKGROUND OF THE INVENTION

The present invention generally relates to water filtration purification systems including a plurality of filter cartridges connected together in series for selectively and sequentially removing specific kinds of impurities from an incoming water supply. A typical water filtering system used in purifying water includes a reverse osmosis (hereinafter, “R.O.”) semi-permeable membrane. Typically, the filtration process through an R.O. membrane requires a driving force, most commonly the pressure from a pump or city water lines, to be applied to incoming feed water in order to force the feed water through the membrane. The membrane filters impurities from the feed water leaving the impurities on the feed water side of the membrane, and purified product water on the other side of the membrane. Most R.O. filtration technology also uses a process known as crossflow to allow the membrane to continually clean itself. In this process, only a portion of the feed water passes through the membrane becoming product water. The portion that does not pass through the membrane is flushed downstream for disposal through a drain port, thus sweeping the rejected impurities away from the membrane and reducing the scaling that occurs on the surface of the membrane. Many applications require that more than one filter be employed in series to selectively remove specific impurities. This series of filters is needed due to the fact that some R.O. membrane filters and other specialty filters are sensitive to, or do not work well if the incoming water contains certain chemicals or impurities, like chlorine for example. In these situations, the chlorine is first removed from the feed water by passing through an upstream pre-filter before moving to the chlorine-sensitive filter or R.O. membrane positioned downstream in the R.O. filtration system.

R.O. filtration purification systems are increasingly being employed to purify municipal and well water supplies to provide improved drinking water by decreasing the total dissolved solids in the municipal or well water, and thereby improving the taste, odor, or chemical makeup of the water.

Therefore, today there are many versions of R.O. filtration purification units that reduce specific contaminants and/or organics to improve the quality of drinking water. Filter and R.O. membrane cartridges (hereinafter “filter cartridges”) utilized in R.O. water treatment systems generally have a standardized cylindrical configuration including entry and outlet structures for attaching the filters to other system elements. Filter cartridges commonly utilized today also have different standardized diameters and lengths depending on whether the filter cartridge is meant for residential or commercial use. Many of the filter cartridges used in the market today are placed by hand in standardized cup shaped filter housings then attached to the main filter manifold. Once the filter housing is attached to the main filter manifold, the combined filter housing and manifold form a pressure vessel commonly called a filter sump. Incoming feed water then passes into the filter sump under pressure via an inlet port, through the filter cartridge contained therein, and exits the filter sump via an exit port in the filter manifold.

Current R.O. water treatment systems employ various techniques to attach the filter housings, which house the filter cartridge, to the main filter manifold. Some systems screw the filter housing to the manifold, some pin the filter housing to the manifold, while still others use bayonet style locking to attach the filter housing to the manifold. There are several disadvantages associated with each of these techniques.

First, a “cup-type” filter housing is essentially a cylindrical cup shaped container in which the filter cartridge is placed before being connected to the main manifold, thus creating a pressure vessel in the form of a filter sump. This type of filter housing has either a threaded lip in order to screw onto a similarly threaded filter manifold, a grooved lip so that it may be clipped or pinned to the filter manifold, or a bayonet style lip to be connected to a manifold that accepts bayonet style sumps. When dealing with “cup-type” filter housings, the user installing the filter cartridge must touch the outsides of the cartridge, including the filter material itself, with his hands in order to install the filter cartridge in the Cup shaped filter sump. This leads to potential contamination of the filter cartridge if proper sanitary methods or protective gear are not used.

Second, because the filter cartridges used in “cup-type” filter housings must be installed in the filter housing by hand, the tested and certified filter cartridges can be potentially altered from their tested and certified state. Additionally, because filter cartridges generally have a standardized configuration, off-brand replacement cartridges may be used which may not carry the certification of the original cartridges, and if used, may void any and all health claims presented to the end user of the main R.O. water treatment system.

Third, another popular proprietary filter housing and filter cartridge used in the marketplace is one in which the filter housing fully encapsulates the filter media within a sealed plastic housing and uses a bayonet locking method to attach the filter to the filter manifold as previously mentioned. This method is an effective deterrent against uncertified aftermarket replacements. It also maintains the sanitary handling desired for that brand of filter cartridge because the filter is encapsulated and certified at the factory. The consumer never has the opportunity to inadvertently or purposely contaminate the filter. However, when replacing the filter cartridge, there is an environmental disadvantage in that the user is not only disposing of the old filter, but he is also disposing the large amount of plastic that was used to encapsulate the filter which may end up in a land fill. This is also an undesirable result.

Fourth, all of the R.O. water treatment system designs currently used in the market today use filter cartridges of preset lengths and diameters. Those systems are designed for use with one filter cartridge size and do not currently have the ability to utilize filter cartridges of varying sizes. This does not allow the user to utilize filter cartridges of larger or smaller diameters or lengths, depending on his particular needs. This is an additional drawback to existing systems.

### SUMMARY OF THE INVENTION

According to the present invention herein disclosed, the main system manifold of the water treatment system includes an upper and lower manifold that are hot plate welded together to form a single unit. The main manifold further includes the cylindrical filter housings which are integrally molded directly into the main manifold, thus forming a solid one-piece manifold with integral filter housings, rather than having the filter housings as separate containers to be attached to the manifold. While other systems also use hot plate welding to create a single manifold design, those systems do not however integrally mold the filter housings into the single manifold. Additionally, the filter cartridges to be inserted into the filter housings include integrated filter housing caps that are permanently connected to the cartridges.

By molding the cylindrical filter housing, which is the main cylinder portion of a traditional filter sump, into the main filter manifold assembly and permanently attaching the filter housing cap to the filter cartridge itself, all handling of the cartridge can be done via the cap thus eliminating potential contamination of the filter media itself. Additionally, the proprietary filter cartridge, which contains an integrated filter housing cap, helps ensure that no after-market or off-brand filters can be used with the main manifold, thus helping to maintain the originally designed health and environmental parameters of the main system. Furthermore, by minimizing the amount of material used in molding the filter housing cap to or permanently attaching the filter housing cap to the filter cartridge, the amount of plastic that may go to a landfill when the filter cartridge is replaced will be minimized as compared to the prior art filter cartridges that fully encapsulate the filter media with plastic.

In another aspect of the invention, the filter housing that is designed to be a R.O. membrane housing contains therein at least two staircased and concentric R.O. membrane brine seal housings of differing diameters and heights. These brine seal housings are sized to accept and allow use of both the standard sized residential R.O. membranes and the standard sized commercial R.O. membranes which each have different brine seal diameters. Additionally, more brine seal housings of differing heights and diameters could also be included which would allow use of membranes with custom brine seal diameters. Thus the invention allows users to change the size of membrane that is being used in the system based on the particular demands placed on the system.

In still another aspect, the invention is a customizable water treatment manifold in that it allows use of filter cylinder extension modules that attach to the integrally molded filter/membrane housings, thus allowing users to utilize filters or membranes of various standard or customizable lengths. Again, the user can choose the length needed based on the particular demands of the system.

In an additional aspect, the invention is a water treatment system that may be connected in parallel to at least one additional identical system such that they form and operate as one single, larger unit. In this manner, water may flow back and forth between each of the two systems for various levels of processing. Furthermore, in yet another aspect, the invention is also a water treatment system which optionally includes an integrated storage tank as opposed to only utilizing a satellite storage tank. The storage tank is customizable to be used as either an integrated tank or a satellite tank. The water treatment system can thus be customized to use either an integrated tank, a satellite tank, or both an integrated tank and satellite tank at the same time as additional storage capacity is needed.

### BRIEF DESCRIPTION OF THE DRAWINGS

FIG. 1 is a front view of a conventional prior art reverse osmosis filtration purification system.

FIG. 2 is an isometric view of a fully assembled water treatment system utilizing a one-piece manifold with integral filter housings made in accordance with the present invention (storage tank not shown).

FIGS. 3 and 4 are exploded views of the main assembly showing the upper manifold and lower manifold.

FIG. 5 is a front view of a residential R.O. membrane cartridge and a commercial R.O. membrane cartridge, each having different brine seal diameters.

FIG. 6A is a cross sectional view of a filter housing cap hot glued onto the end of a carbon block filter cartridge.

FIG. 6B is a cross-sectional view of a filter housing cap spun welded onto a R.O. membrane cartridge.

FIG. 7 is an exploded view of one embodiment of the water treatment system of FIG. 2 (storage tank not shown) utilizing cylinder extension modules.

FIG. 8 is a top view of the R.O. membrane housing of the manifold with integral filter housings of FIGS. 3 & 4 showing the various sized brine seals therein.

FIG. 9 is a cross-sectional view of the manifold with integral filter housings showing the various sized brine seals of the R.O. membrane housing and a corresponding filter cartridge.

FIG. 10A is an exploded view of a filter housing, a filter cartridge with integral housing cap, and a housing cap retaining pin with retaining pin release clip.

FIG. 10B is a side view of a filter housing with a filter cartridge loaded therein and the filter housing cap secured in place by a housing cap retaining pin.

FIG. 11 is a view of the housing cap retaining pin being used as a filter cartridge removal tool.

FIG. 12 is a view of one embodiment of a dedicated filter cartridge removal tool.

FIG. 13 is an exploded view of an integrated water storage tank and the main manifold assembly with an adapter plate mounted there between.

FIG. 14 is a close-up isometric view of the water pathways, pathway gate notches, and corresponding pathway modification gates that fit into the pathway gate notches of the lower manifold.

FIG. 15 is a view of the assembled drain barrel inside the drain flow restrictor port.

FIG. 16 is a close up view of the drain barrel of FIG. 15.

FIG. 17 is an isometric view of an embodiment made in accordance with the present invention wherein two individual main assemblies have been connected by their lower manifold's to form one larger unit.

FIG. 18 is an isometric view of an embodiment made in accordance with the present invention, wherein the main assembly has been combined with an auxiliary piece of equipment such as a fourth filtration sump, a pump, an electronic monitoring and control device, or a UV module.

FIG. 19 is an isometric view of the fully assembled preferred embodiment of the system of FIG. 2, wherein the system of FIG. 2 has been combined with an integrated storage tank as in FIG. 14, and an additional decorative cover.

FIG. 20 is an isometric view of the system made in accordance with the present invention wherein the storage tank utilized is a separate satellite storage tank.

FIGS. 21 & 22 are isometric views of alternate embodiments of the storage tank made in accordance with the present invention, wherein the tank is used as a satellite storage tank, is physically linked to a second storage tank using the tank's mounting fasteners and a plurality of universal mounting brackets.

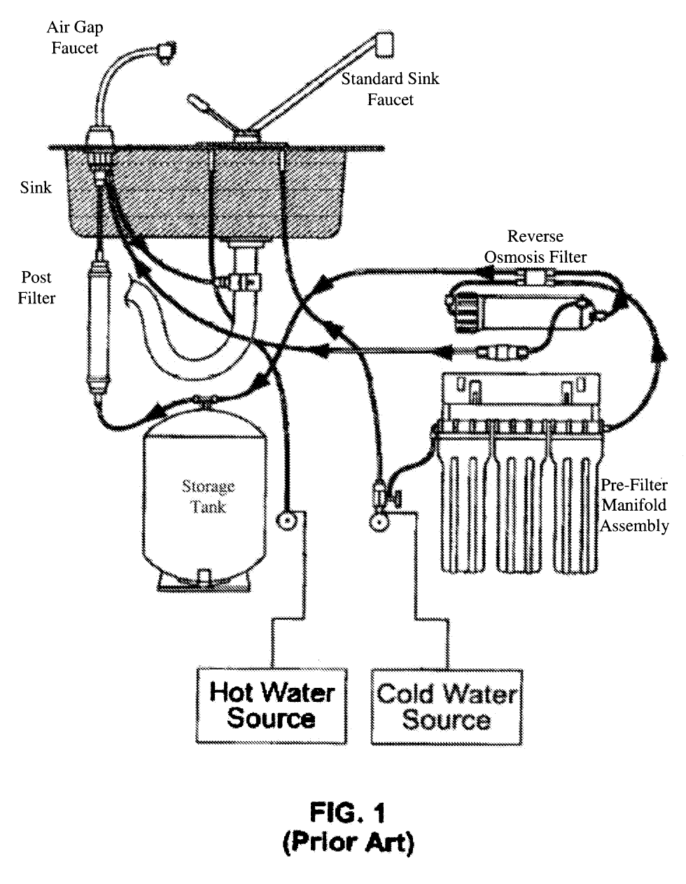

### DETAILED DESCRIPTION OF THE INVENTION

While the present invention is capable of embodiment in various forms, there is shown in the drawings, and will be hereinafter described, one or more presently preferred embodiments with the understanding that the present disclosure is to be considered as an exemplification of the invention, and is not intended to limit the invention to the specific embodiments illustrated.

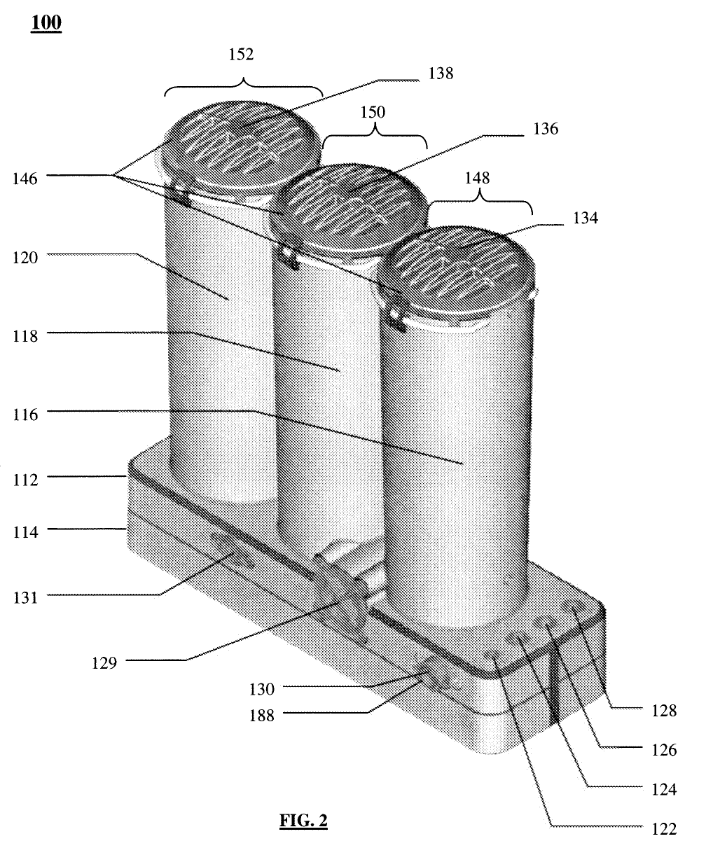

Referring to FIG. 2, water filtration system 100 of the present invention is disclosed. System 100 includes a lower manifold 114, an upper manifold 112, a plurality of filter housings 116-120, a plurality of filter cartridges 134-138 each including an integrated filter housing cap 146 (of which only the filter housing caps 146 are visible in FIG. 2), and a storage tank 194 (shown in FIGS. 14 & 19-22).

In the preferred embodiment, the upper manifold 112 and lower manifold 114 are generally rectangular in shape, however, the disclosure of this embodiment should not be read to limit the shape of the upper and lower manifolds. The filter housings 116-120 and the filter cartridges 134-138 seated primarily inside of the filter housings 116-120 (See FIG. 9), are generally cylindrical in shape. The filter housing caps 146 of the filter cartridges 134-136 are also generally cylindrical in shape and form a liquid tight seal with the inner walls of filter housings 116-120. However, the disclosure of this embodiment should not be read to limit the shape of either the filter housings 116-120, the filter cartridges 134-138, or the filter housing caps 146. Rather the filter housings 116-120 and filter housing caps 146 are shaped to accommodate and compliment the shape of the filter cartridges 134-138. As such, in alternate embodiments of the matter disclosed herein, the filter cartridges, housings, and filter housing caps may take on additional shapes other than those disclosed herein. Additionally, although the preferred embodiment of FIG. 2 depicts three filter housings 116-120 and three filter cartridges 134-138, this should not be read to limit the number of filter cartridges 134-138 or housings 116-120 that may be incorporated in the practice of alternate embodiments of the matter disclosed herein.

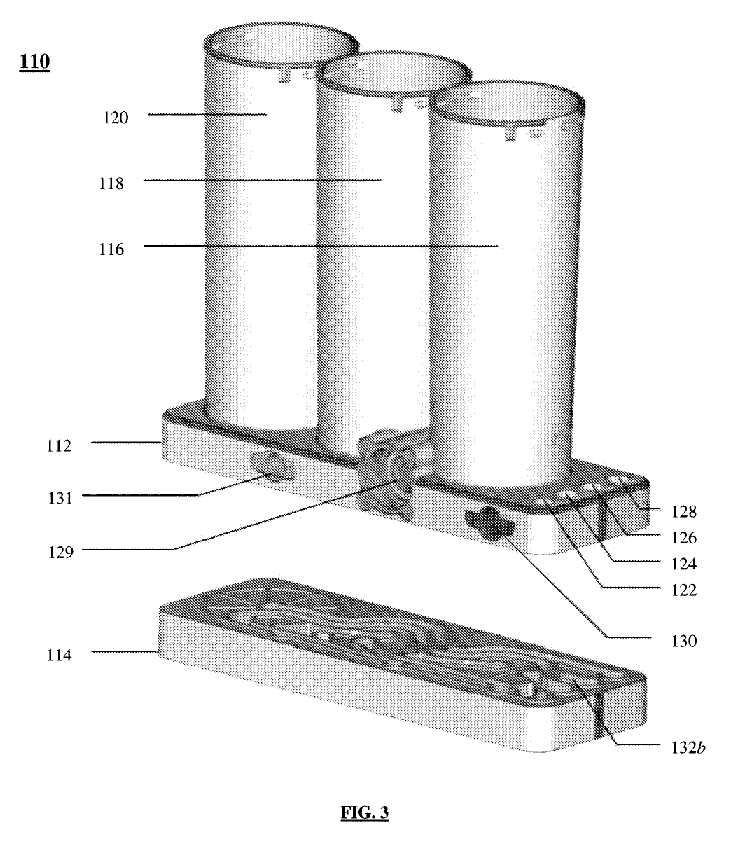

Referring to FIGS. 3 & 4, the upper manifold 112 includes filter housings 116-120, which are integrally molded thereto, forming a single molded piece. In the preferred embodiment, the integrally molded filter housings 116-120 of upper manifold 112 are a sediment pre-filter housing 116, an R.O. membrane housing 118, and a carbon post-filter housing 120. However, the disclosure of this embodiment should not be read to require that a R.O. filter always be utilized in the practice of this invention nor should the disclosure of this embodiment be read to limit the use of the filter housings to only those filters previously discussed. Alternatively, in other embodiments, the filter housings may be used for alternate types of filters and/or membranes such as, but not limited to, sediment filters, sediment/carbon block combination filters, carbon block filters, granulated activated carbon filters, and KDF filters and may be arranged in a different order than that disclosed herein. Additionally, upper manifold 112 also includes all manifold control ports which are the inlet control port 124, the satellite storage tank control port 126, the faucet control port 128, and the drain water control port 122. The upper manifold 112 further includes a drain flow restrictor port 130, a shutoff diaphragm valve port 129, a check valve port 131, and the upper half of the water pathways 132a (see FIGS. 3 & 4). The function of the check valve port 131 is to prevent water contained in the storage tank from draining back to the drain port control 122 when the air gap faucet connected to the faucet control port 128 is shut off and not dispensing product water.

The lower manifold 114 includes the lower half of the water pathways 132b (see FIG. 3) and a plurality of fluid flow configuration ports 140 (see FIG. 4). Both the upper manifold 112 and the lower manifold 114 are made from a high strength material such as, but not limited to, GFN3 which is 30% glass filled Noryl (a polymer manufactured by GE Plastics), GTX (a polymer manufactured by GE Plastics), or Xyron (a polymer manufactured by Asahi Thermofill, Inc.). The upper manifold 112 and the lower manifold 114 are hot plate welded together to form the main filter assembly 110, (see FIGS. 3 & 4) which thereafter is one solid piece. When the upper and lower manifolds 112 & 114 are hot plate welded together, the upper half of the water pathways 132a aligns and seals with the lower half of the water pathways 132b to become one hermetically sealed set of water pathways 132. Although in the preferred embodiment the upper and lower manifolds are hot plate welded together, in alternate embodiments, they may be fusion bonded together, sonic welded together, or joined together in any other manner that provides a hermetic seal therebetween.

Having the filter housings 116-120 molded into the upper manifold 112, and thus the main assembly 110 following the hot plate welding procedure, is unique to the R.O. system 100 disclosed herein. The advantages of integrally molding the filter housings 116-120 into the system's main assembly 110 will be discussed below.

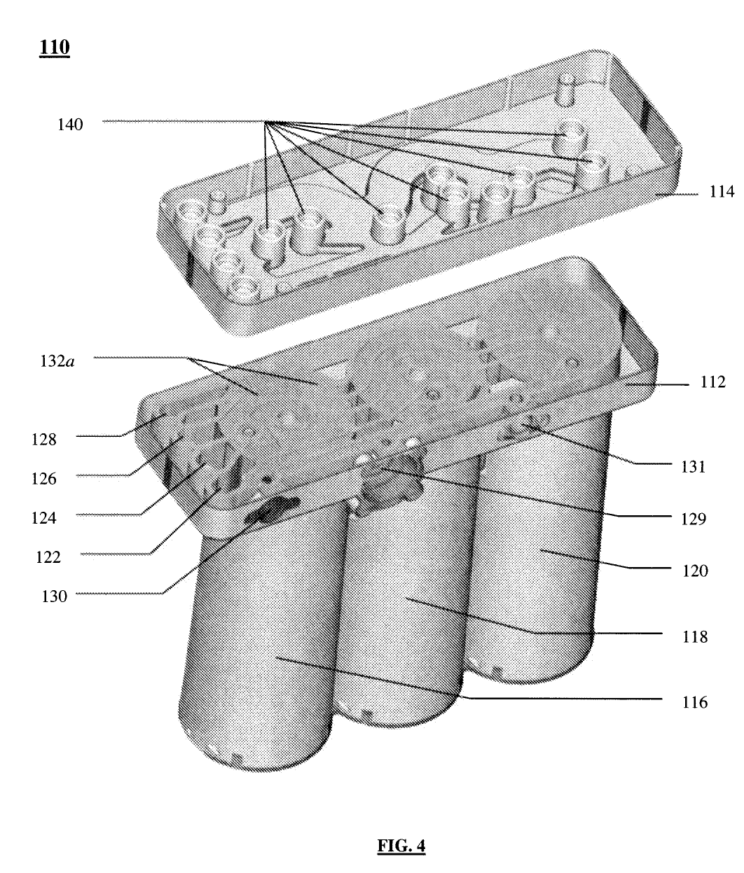

Referring to FIG. 5 specifically depicting a residential 160 and a commercial 166 R.O. membrane cartridge, but generally applicable to all filter cartridges, the filter cartridges 134-138 include a filter media portion 168, a filter housing cap 146, and a fluid seal connector 169. If the filter cartridge is an R.O. membrane cartridge as in FIG. 5, then the filter media portion 168 is essentially a molded, hollow, and perforated plastic tube, having multiple layers of various filter materials wrapped thereon. If, however, the filter cartridge is a pre or post-filter such as a carbon block filter, then the filter media portion 168 is generally either a porous, extruded cylindrical filter media solid having a hollow cylindrical center, or it is a perforated cylindrical plastic housing filled with a particular granulated filter media (not shown). The creation of various types of filter media is well known in the art and will be understood by those skilled in the art and will not be repeated herein. The filter media 168 is the portion of a filter cartridge through which feed water is forced in order to remove the water's impurities. Generally, feed water surrounds the outer cylindrical surface of the filter media portion, passes through the outer surface of the filtration media and into the hollow center, and travels down the hollow center and out of the filter housing in order to move downstream to the next filtration stage.

The filter housing cap 146 is generally a cylindrical, tubular sidewall that is closed off at one end by a concentric, circular shaped top wall joined thereto. The cap 146 includes a mating and sealing portion defined by the outer surface of the cap's 146 cylindrical sidewall and further includes a decorative domed grill on the outer surface of the circular shaped top wall. The inner surface of the cap's 146 top wall is generally flat. The cap 146 is generally made from high strength plastic but can be alternatively made from other high strength materials. The filter housing cap 146 includes at least one liquid sealing o-ring 147 seated around the outer circumference of the mating portion of the filter housing cap 146, a retaining pin retention groove 176 recessed in the full outer circumference of the cap and positioned between the o-rings 147 and the cap's 146 top wall, and a plurality of housing cap removal tool holes 180 situated in the outer decorative grill of the housing cap 146. The o-rings 147 are what form the liquid tight seal between a filter housing 116-120 and the filter housing cap 147 when the two are mated together. The retention groove 176 is the feature on the cap 146 that, when engaged by a retention pin 170, keeps the housing cap secured in place when the filter sumps 148-152, which are the pressure vessels formed by mating the cartridges into the filter housings, become pressurized due to water flowing through the system 100. The cap removal tool holes 180 are essentially thru holes into which a cap removal tool 182 is hooked to help pull the mated housing cap 146 off of the filter housings 116-120 when the filter cartridges need to be removed.

The fluid seal connector 169 is the portion the filter cartridge 134-138 that connects the filter media portion 168 to the manifold's housing outlet port 186. It also provides the path through which water, which has just passed through a particular filter inside of a filter sump, is reintroduced back into the manifold's water pathways 132 for further processing downstream or for dispensing, depending on where the particular filter is located in the process. The fluid seal connector 169 includes a filter connection nipple 163 containing at least one o-ring 147 thereon, such that, when the nipple 163 is mated with the housing outlet port 186, a fluid tight seal is created there between, thus reducing the possibility that unfiltered water can reenter the system prior to being filtered. Also, when the filter in question is a R.O. membrane filter, the fluid seal connector 169 further contains a brine seal 158 or 164 which forms a liquid tight seal with an appropriately sized brine seal housing 156 or 162. The liquid tight seal formed between the brine seal 158 or 164 and brine seal housing 156 or 162 separates the pre-filtered inlet water coming into the membrane sump 150 from the crossflow drain water which leaves the system as waste for disposal.

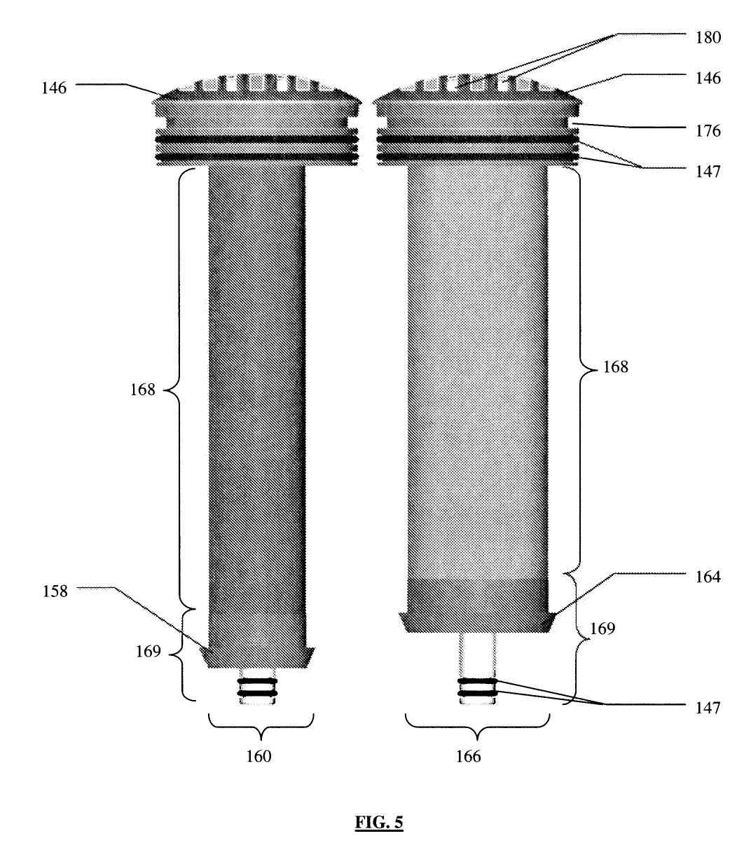

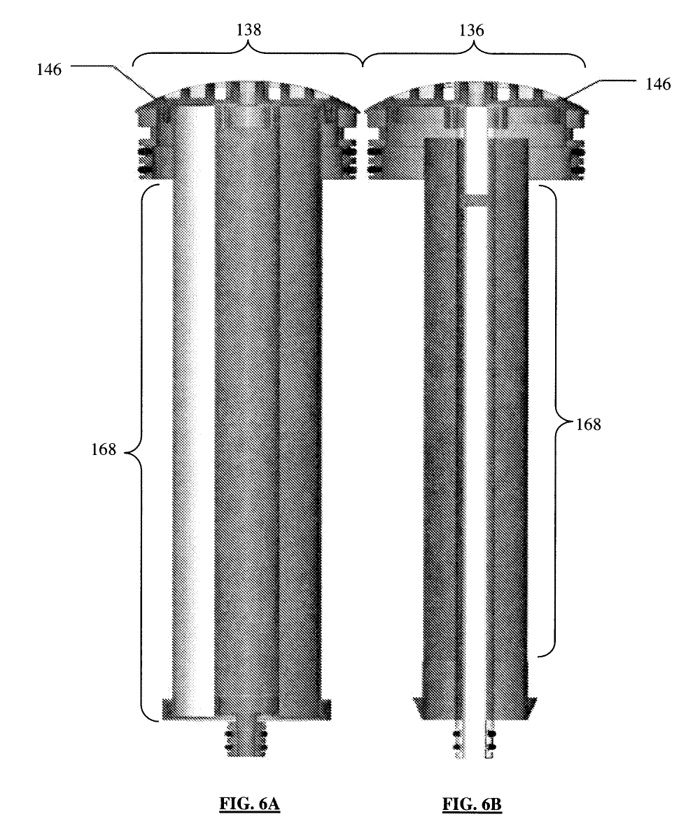

Referring to FIG. 6B, for the R.O. membrane cartridges 136, the cap 146 is preferably spun welded onto the molded tube portion of the filter media 168, thus becoming permanently attached or incorporated into the cartridge and creating a new proprietary disposable filter cartridge. Alternatively, the filter housing cap 146 can be integrally molded into a filter cartridge, snapped or press-fit onto the filter media portion 168, or glued onto the end of the filter media portion as is done with many carbon block filters and seen in FIG. 6A, thus creating one solid cartridge and cap unit. Referring to FIG. 6A, when the cap 146 is hot melt glued to the open end of an extruded carbon block filter, the glue forms the seal on the open end of the hollow cylinder preventing water from entering into the center of the cylinder without first passing through the filtration material. With such a filter cartridge design, if the filter media portion 168 of a filter cartridge 134-138 is removed or separated from the filter housing cap 146, it renders the filter cartridge unusable. In a preferred embodiment, filter cartridges 134-138 are a sediment pre-filter cartridge 134 to be loaded into the pre-filter housing 116, a R.O. membrane cartridge 136 to be loaded into the R.O. membrane housing 118, and a carbon post-filter 138 to be loaded into a post-filter housing 120.

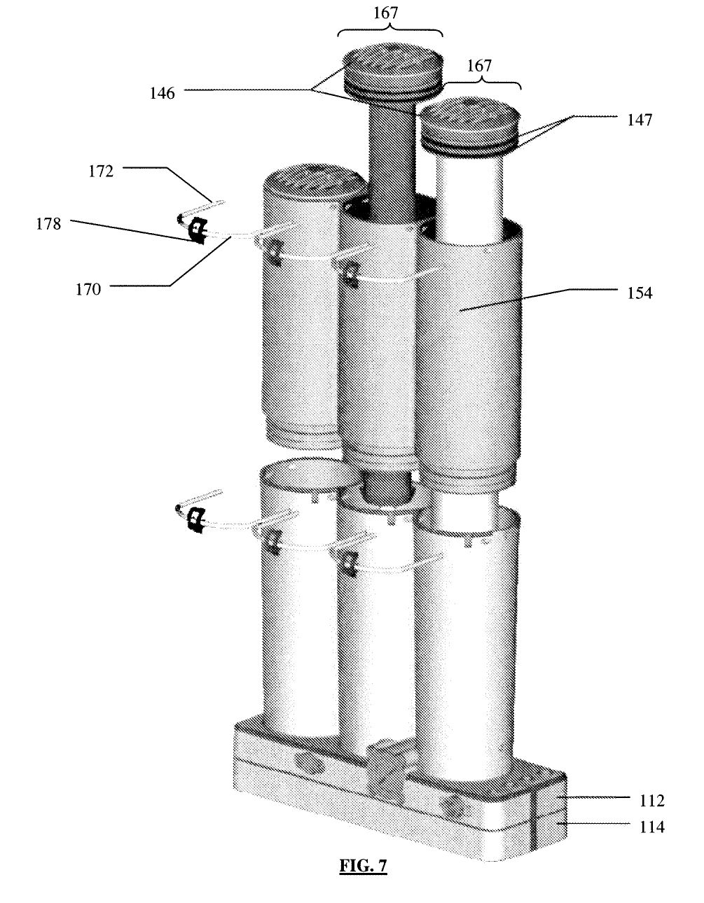

When each filter housing 116-120 is capped off with a filter housing cap 146 containing at least one o-ring seal 147, the combined parts form a series of sealed filter sumps 148-152, as previously mentioned. A filter sump is simply a pressure vessel, inside of which water will pass, under pressure, through the filter media 168 of the filter 134 and 138 or membrane 136 contained therein. Referring to FIG. 7, because of the system's integrated filter housings 116-120, an alternate embodiment of the invention disclosed herein allows for use of cylinder extension modules 154 to be coupled to the open, uncapped ends of the filter housings 116-120. The caps 146 may then be secured to the open ends of the cylinder extension modules 154 creating a liquid tight seal. In this manner, the main assembly 110 is altered to allow the system 100 to use longer filter cartridges 167 which in turn will increase the product water output potential.

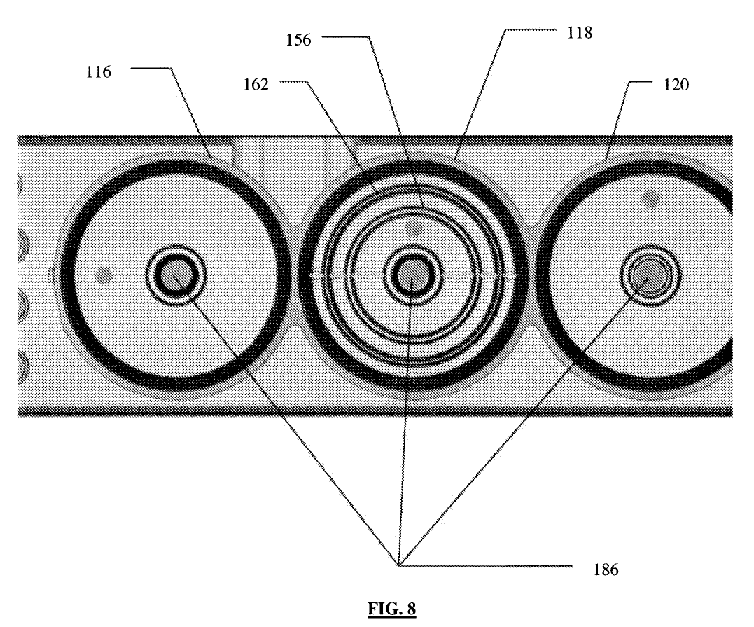

Referring to FIGS. 5 & 8-9, the aforementioned filter housings 116-120, at either their standard lengths or extended lengths, via cylinder extension modules 154, are capable of receiving multiple filters and membranes of various diameters. The membrane housing 118 specifically has, but is not limited to, two staircased brine seal housings 156 and 162 attached to the flat, bottom, inner surface of the membrane housing 118 and extending upwards in the same direction as the housing itself (See FIGS. 8 & 9). The first brine seal housing 156 has been sized to accept the brine seal 158 of the standardized residential diameter R.O. membrane cartridge 160 while the second brine seal housing 162 has been sized to accept the larger diameter brine seal 164 of standardized commercial diameter R.O. membrane cartridges 166 (See FIG. 5). Alternatively, additional brine seal housings may be utilized and sized to accept unique membrane brine seals of nearly any diameter in the practice of an embodiment of the invention disclosed herein.

The preferred embodiment which incorporates the cap 146 and filter cartridge 134-138 into one unit has several advantages over prior standard cartridge configurations. First, when installing most standard filter cartridges, the filter media must be touched by the user's hand creating the potential to contaminate the filter media 168 and the entire system if proper sanitary methods or protective gear is not used. However, when using the one-piece manifold with integral filter housings, all handling and installation is done by the outside edges and surface of the cap 146 which never comes in contact with the water in the system 100, thus eliminating the potential contamination of the filter media 168. Second, unlike current filter cartridges, tested and certified filtration media cartridges made in accordance with the invention cannot be altered from their tested and certified state. Many off brand replacement filters do not carry the certification that the original cartridges do and if used may void any/all health claims presented to the end user of the main RO unit. By controlling the supply of certified filter cartridges, the manufacturer can ensure the product works as claimed. Third, unlike a popular proprietary filter cartridge used in the market today that fully encapsulates the filter media within a sealed plastic housing, the one-piece manifold with integral filter housings minimizes the amount of plastic that may end up in landfills upon disposal of the filter cartridge. When the aforementioned fully encapsulated filter media is disposed of, the user is disposing of not only the filter media inside, but the fairly large plastic housing that fully encapsulates the filter media as well. With most other filtration systems, this plastic filter encapsulation housing is usually meant to be a detachable, yet permanent part of the main system and is normally reused after replacing the filter media contained therein. By comparison, upon disposal of the filter cartridges 134-138 of the present invention, the filter media 168, the filter housing cap 146, and the filter connection nipple 163 are the only parts disposed of, while the main filter housings 116-120 which make up the largest portion of the filter sumps are reused with the new replacement filter cartridges. The obvious environmental advantage is that significantly less plastic may be disposed of in landfills upon cartridge replacement.

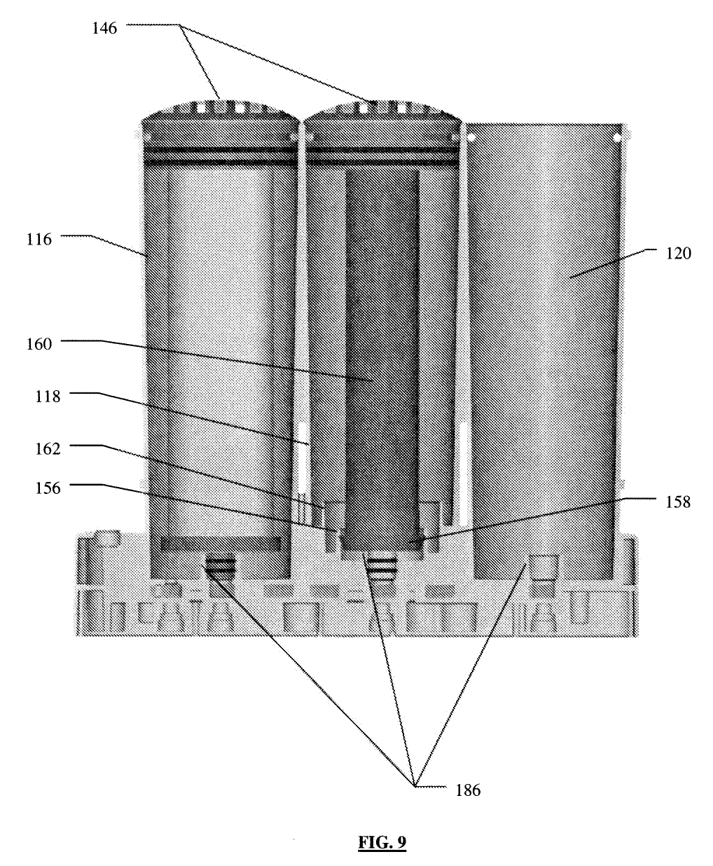

Referring to FIGS. 7, 10A, and 10B, each cap 146 is secured to its filter housing 116-120 or cylinder extension module 154 by pinning the cap 146 to the open end of the filter housing 116-120 or cylinder extension module 154 using a horseshoe shaped retaining pin 170. The filter cartridge 134-138 is first inserted into the filter housing 116-120 and the integral filter housing cap 146 containing o-rings 147 is fully seated in the open end of the filter housing 116-120. Next the legs 172 of the retaining pin 170 are inserted through corresponding retaining pin engagement holes 174 located in the walls of the filter housing 116-120. The legs 172 of the pin 170 slide through the engagement holes 174 in the filter housing 116-120, engaging the corresponding retention groove 176 above the o-rings 147 in the outer circumference of the filter cap 146, and emerging from pin engagement holes 174 on the opposite side of the filter housing 116-120. When the legs 172 of the retaining pin 170 are engaged in the cap's retention groove 176, they create an interference fit, thus securing the cap 146 in place and preventing it from being removed.

The retaining pins 170 that secure both the housing caps 146 in place and the filter cartridges 134-138 inside the filter housings 116-120 may become difficult to remove after the filter sumps 148-152 have been pressurized for a long time. To aid in the removal of the retaining pin 170, a release clip 178 is attached to the retaining pin 170. The release clip 178 is manually pulled downward and the resultant lever action against the filter housing 116-120 ejects the pin 170 or moves the pin free from its resting place making it easier to remove. While the preferred embodiment uses pinning as the preferred method to connect the filter housing caps 146 or cylinder extension modules 154 to the filter housings 116-120, alternatively the caps 146 and cylinder extension modules 154 can be connected by screwing, bayonet style locking, or any other method that would provide a secure connection between the caps 146 and housings 116-120, the caps 146 and extension modules 154, or the extension modules 154 and housings 116-120.

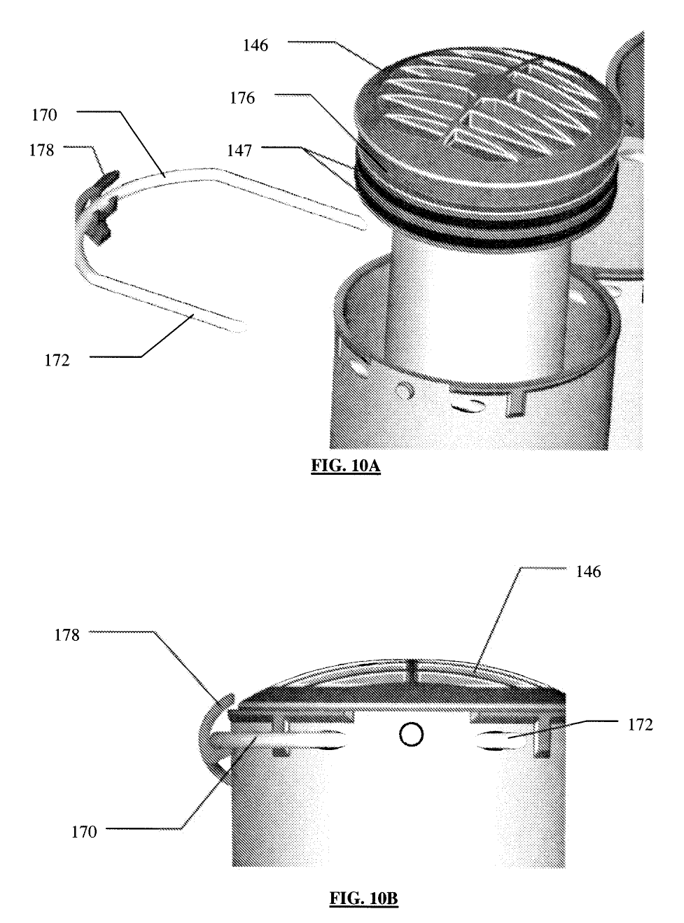

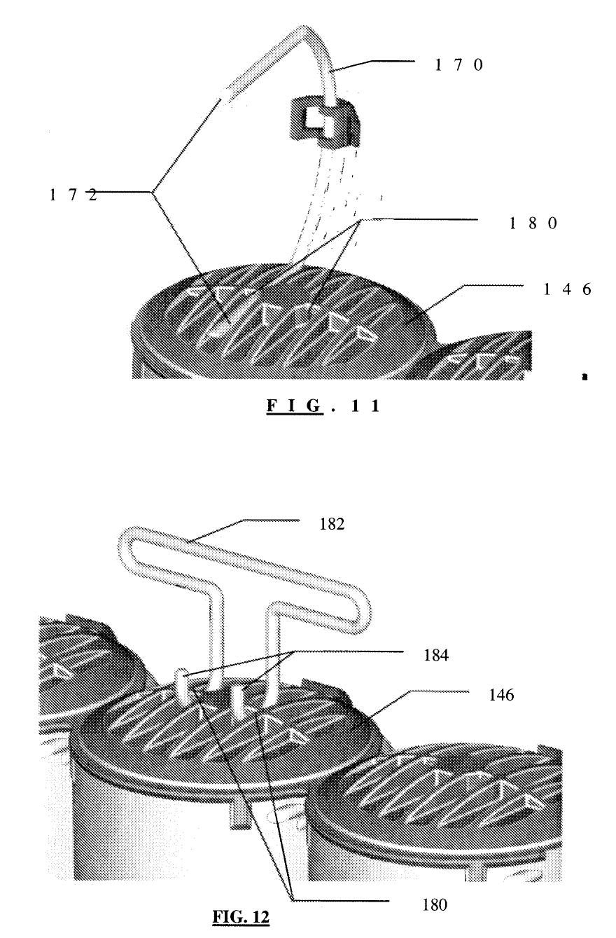

Referring to FIGS. 11 and 12, the retaining pin 170, after it is removed, can also function as a filter cartridge removal tool. One leg 172 of the retaining pin 170 is inserted into one of a plurality of cap removal tool holes 180 located in the outer surface of the filter housing cap 146 and is used to twist and pull up on the filter cartridge's integral cap 146 in order to remove the filter cartridge 134-138 from its filter housing 116-120 (See FIG. 11). Preferentially however, a specially designed removal tool 182 that aids in the removal of filter cartridges 134-138 is employed to remove the filter cartridges 134-138. The tool 182 is essentially a T-shaped handle with hooks 184 located on the vertical portion of the T that are used to engage the cap removal holes 180 in the filter cap 146. The tool 182 is then used to twist and pull upwards on the filter cartridge 134-138 to remove it from the filter housing 116-120 (See FIG. 12). Alternatively, the tool can take the form of many other shapes as well, such as a simple U-shape.

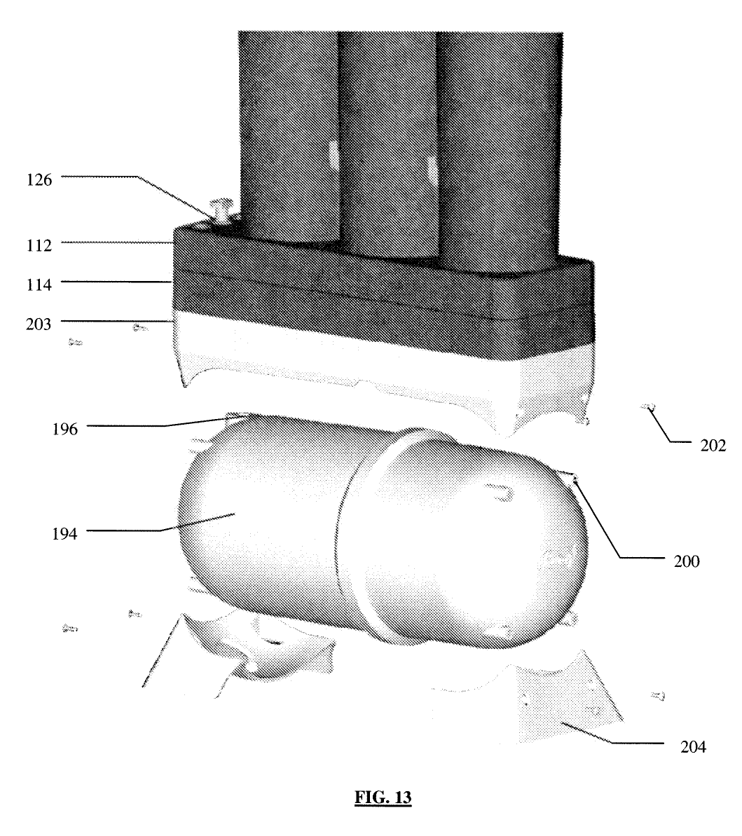

Referring to FIG. 13, due to the naturally long time it takes to process water through a R.O. membrane, a pressurized storage tank 194 is usually employed in the system 100. Water which has already passed through the R.O. membrane collects and is temporarily stored in the storage tank 194 when the air gap faucet, through which the water will ultimately be dispensed, is shut off. Once the air gap faucet is opened, the pressure in the storage tank 194 is sufficient to force the treated water out of the tank, either for dispensing and use if it is fully processed product water, or for further processing downstream if it has been only partially-treated. In the preferred embodiment, the storage tank 194 is generally cylindrical in shape with hemispherical ends, however, the disclosure of this embodiment should not be read to limit the shape of the storage tank.

The tank 194 includes at least one tank fluid flow port 196 through which water enters and leaves the storage tank. The tank fluid flow port 196 is connected to either, the satellite storage tank control port 126 of the upper manifold 112 in the main assembly 110 if the tank is a satellite tank, or it is connected to one of the pathway configuration ports 140 (not visible in FIG. 13) of the lower manifold 114 in the main assembly 110 if the tank is an integrated tank. The tank 194 also includes an internal sealed, gas-pressurized bladder 198 (not visible). This bladder 198 is what provides the pressure to the water stored in the tank 194 in order to force it out of the tank 194 once the air gap faucet is opened. The internal workings of the tank 194 are well known in the art and therefore will not be addressed in any great detail. The tank 194 further includes a plurality of threaded fasteners 200, integrally disposed in the outer surface of the storage tank 194. Standard system designs use a satellite storage tank that is separated from the main filtration system assembly 110. In the preferred embodiment however, the fasteners 200 allow the tank to mount to the main assembly 110 (See FIGS. 13 & 19) using threaded posts such as screws 202 or bolts and an integrated tank adapter plate 203 attached to the lower manifold 114, thus creating an integrated single-unit R.O. system. Alternatively, the fasteners 200 may be snap-type cantilevered beams, holes to accept rivets or pins, bayonet type mounting holes to accept bayonet type screws, or any fastening means that will provide a robust field-removable linkage between the tank and the main manifold assembly 110.

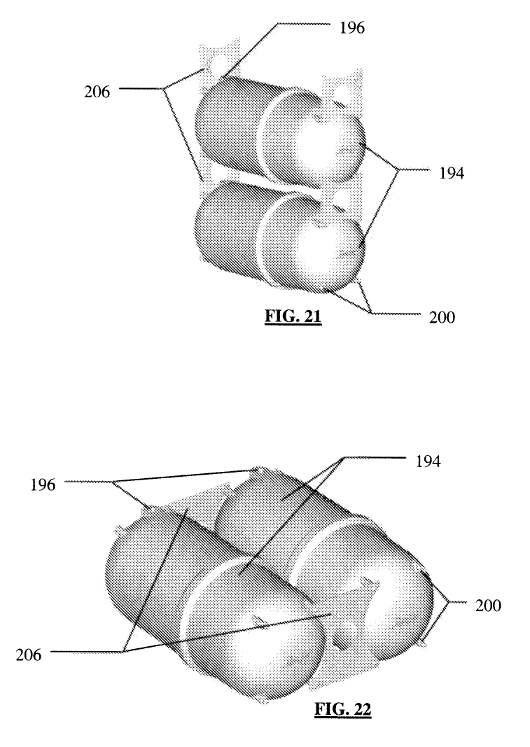

Referring to FIG. 13, in the preferred embodiment, the tank also includes removable legs 204 which fasten to the tank 194 in the same manner as the tank fastens to the main assembly 110. When the tank is used as a satellite tank, the legs 204 can be removed and reattached to the tank 194 via the fasteners 200 and screws 202 at another location on the tank's surface, in order to change the resting orientation of the tank 194 (See FIG. 20). Additionally, in alternate embodiments, more than one tank may be utilized to increase the storage capacity by using both an integrated tank and a satellite tank as described above, or, referring to FIGS. 21 & 22, by using multiple satellite tanks that are physically linked together via a plurality of removable universal mounting brackets 206 and the fasteners 200 and screws 202 previously discussed. Furthermore, using the removable brackets 206, the satellite tanks may be mounted to various structures in multiple orientations as needed, such as hanging vertically from a ceiling rafter or mounting horizontally to a wall.

In operation, the preferred embodiment of the invention disclosed herein works as follows: the filter cartridges 134-138 are loaded into the filter housings 116-120 and the integral filter housing caps 146 are secured in place with retaining pins 170. Impute feed water enters the system via an inlet control connection port 124 and travels through the pre-filter 134, the R.O. membrane 136, and the post-filter 138 via the hermetically sealed water pathways 132. Referring to FIG. 4, the design of the lower manifold 114 is unique in that it has multiple pathway configuration ports 140 molded into it in a closed state to optionally be opened and used for alternate water pathway configurations. Additionally, referring to FIG. 14, incorporated into the lower manifold's 114 design are multiple pathway gate notches 142 within the water pathways 132 that accept separate pathway modification gates 144. The purpose of the configuration ports 140, gates 144, and notches 142 is to force the water to travel alternate paths and to flow into or out of various attachments when alternate embodiments are employed. Depending on the desired water flow path in and out of the main assembly 100, prior to hot plate welding the upper 112 and lower 114 manifold together, select configuration ports 140 are drilled open and gates 144 are press fit or sonic welded into specific notches 142 in order to shut off specific internal ports or close off specific pathways 132. This effectively changes the path the water will take through the water pathways 132 and the main assembly 110, or changes the order in which the feed water enters the various filter sumps 148-152. The opened configuration ports 140 are then connected to other opened ports 140 by tubes. In this manner, the system can be configured in a variety of ways to perform a variety of desired tasks. This procedure is also how the ports 140 are opened up to allow water to flow into and out of an integrated storage tank 194 as previously discussed as opposed to only utilizing a separate satellite storage tank. Referring to FIG. 17, this design thus allows, in an alternate embodiment, two fully assembled main assemblies 110 to be joined to form a single unit by blocking their proper water pathways 132 with gates 144, opening their proper configuration ports 140, connecting their corresponding opened pathway configuration ports 140 with tubing, and mounting the lower manifolds of the two assemblies 110 together using an adapter plate (not shown). By doing so, water can flow between the two sets of water pathways of the two main assemblies 110.

In the preferred embodiment, after entering the system via the inlet control port 124, the impure feed water is first channeled down the water pathways 132 and into a pre-filter sump 148 containing a sediment pre-filter 134 used to remove dirt, sand, and other suspended solids. The feed water passes, under pressure, through the pre-filter 134 and exits the pre-filter sump 148 via a filter housing outlet port 186 where it re-enters the water pathways 132.

Next, depending on the configuration of the water pathways 132, the water enters an R.O. membrane sump 150 containing the R.O. membrane 118 used to remove bacteria, salts, and other dissolved solids. Most of the water in the membrane sump 150 passes through the membrane 118 contained therein, thus filtering out most of the total dissolved solids in the water. The water exits the R.O. membrane sump 150 in one of two paths. The first path is for water that passes through the R.O. membrane 118, which is not the path taken by the majority of the water in the sump 150. The first path carries the membrane filtered water from the R.O. membrane sump 150 down the water pathways 132 to a tank control port 126 which is connected to a satellite storage tank 194. The storage tank 194, pressurized to less than the feed water line pressure, holds the R.O. filtered water until an air gap faucet connected to the main assembly 110 is opened by a user. Once the faucet is opened, the water stored in the storage tank 194 is forced out of the storage tank 194 by the gas-pressurized bladder 198 contained therein. The water flows back through the tank control port 126 of the main assembly 110 and back into water pathways 132 of the main assembly 110, where it then enters a post-filter sump 152 containing a carbon filter to remove impurities that affect the water's taste and odor. Once the water passes through the carbon post-filter, it leaves the post filter sump 152, enters the water pathways 132 one last time, and travels through a faucet control port 128, which is connected to the air gap faucet, in order to dispense the water from the faucet when called for by the user.

The second path through which water may exit the R.O. membrane sump 150 is for drain water which is routed to a drain water flow restrictor 130. This is the path through which the majority of the water in the sump 150 flows. The large portion of the pre-filtered feed water that does not pass through the R.O. membrane 136 leaves the R.O. membrane sump 150 sump via a filter housing drain port located on the same side of the membrane as the housing's inlet port. This water is essentially concentrated waste water containing all of the impurities filtered out during the R.O. filtration process, which then leaves the system 100 through the main assembly's 110 drain control port 122 as drain water for disposal. By splitting off part of the incoming water as drain water rather than forcing all of the incoming feed water through the R.O. membrane 136, the R.O. membrane 136 is constantly being cleaned and having the impurities discarded rather than allowing them to build up on and clog the pores of the membrane surface, thus significantly extending the life of the R.O. membrane 136 and the time until the membrane 136 needs to be replaced.

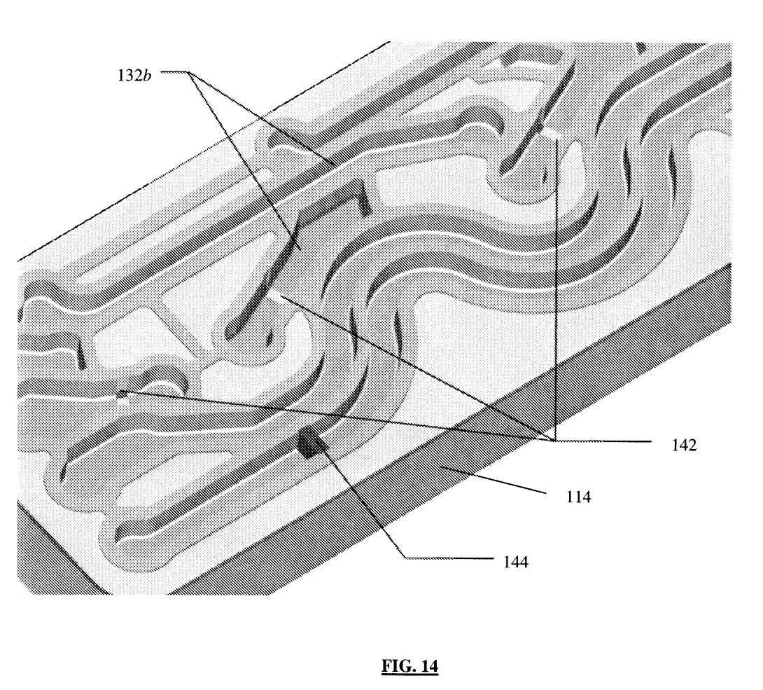

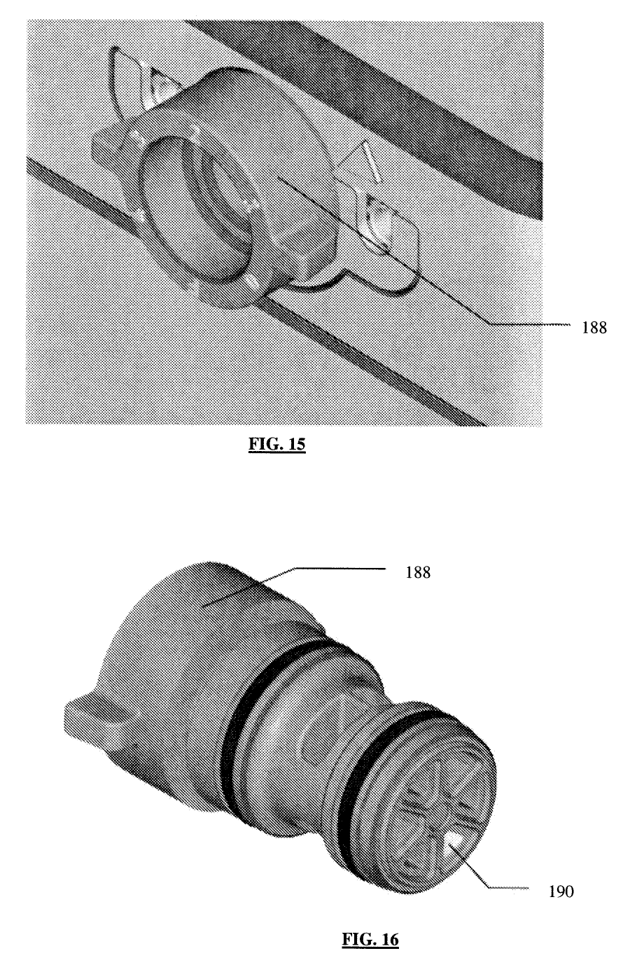

Referring next to FIGS. 15-16, all R.O. units need to control the rate at which drain water leaves the membrane sump 150 while processing water through the R.O. membrane 136. The cleaner the feed water, the less drain water needs to be split off and discarded. Controlling the drain rate is accomplished via the drain flow restrictor port 130 which contains a drain control barrel valve 188. The drain barrel 188 has several orifices 190 located within it, through which drain water flows, which may be selectively opened or closed to increase or decrease the flow of the drain water. The drain barrel 188 is rotated in order to select various predetermined drain rates or ratios of drain water to product water. Two additional settings outside of the necessary incorporated drain ratios are “off”, which is a setting that completely closes the orifices 190 of the drain barrel and does not allow any water to flow through the drain flow restrictor 130, and “fast flush,” which fully opens the drain barrel orifices 190, flushing the majority of the water in the sump 150 to the drain for disposal. As membrane production rate technology improves, the need to send water to drain may be eliminated. The “off” position can be used for any reason no flow through the drain barrel 188 is desired, while the “fast flush” position allows for manually flushing the existing membranes currently being used in the industry. Alternatively, similar drain functions can be achieved in the practice of an embodiment of the matter disclosed herein by use of needle valves, ball valves, or any other valve technology which allows a user to selectively adjust flow rates through said valve.

Referring to FIGS. 17-19 showing alternate embodiments of the matter disclosed herein and as previously discussed, the lower manifold 114 is designed such that the main assembly 110 can accept accessory filtration devices or peripherals to it, or can be mounted directly to other drinking water devices. The design allows for two or more R.O. unit main assemblies 110 to be connected to each other and work as one larger unit (See FIG. 17). Additional alternate embodiments of the matter disclosed herein include the incorporation of, but are not limited to: auxiliary filter housings that can be implemented at any filtration stage desired; pumps, electronic monitoring and control devices, and UV modules connected to or mounted to the main assembly 10 (See FIG. 18); office water coolers and drinking fountains connected to or mounted to the main assembly 110. The ability to incorporate electronic monitoring and control devices and other peripherals discussed above into various embodiments of the matter disclosed herein allows for an “auto flush” system to perform the drain rate monitoring functions, “fast flush” functions, and “no flow” functions discussed above, on time-based or volume-based flushing or cleaning schedules. Additionally, when an electronic monitoring and control module is incorporated by itself into an embodiment of the matter disclosed herein or with other incorporated modules, alarms can be used to indicate important information such as, but not limited to, filter replacement timelines, cleaning schedules, or unit maintenance.

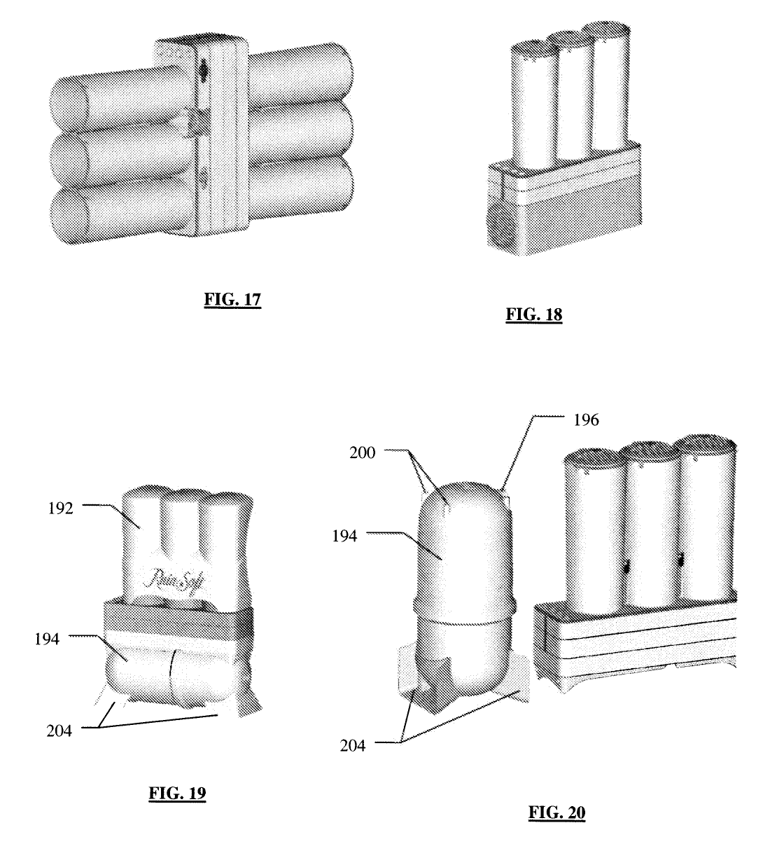

Furthermore, in yet another embodiment, the system can utilize secondary membrane housings and be configured to allow parallel flow through two or more membranes 136. Additionally, in yet another embodiment, a decorative cover 192 fits over the main assembly 110 to create the attractive appliance feel that the main assembly 110 is lacking (See FIG. 19). The cover 192 uses a variety of shapes and contours that accentuate the existing main assembly.

While the present invention has been described in terms of the embodiments depicted in the drawings and discussed above, it will be understood by one skilled in the art that the present invention is not limited to these particular embodiments, but includes any and all such modifications that are within the spirit and the scope of the present invention as defined in the appended claims.

What is claimed is:

1. A water treatment system comprising:
a manifold;
a plurality of water treatment filter housings, fixedly connected to said manifold and having an open end for receiving a plurality of water treatment filter cartridges, wherein said filter cartridges have a first end and a second end;
a plurality of filter housing inlet and outlet ports disposed between said manifold and said filter housings, wherein said housing outlet ports matably engage said first end of said filter cartridges;
a plurality of filter housing caps, fixedly attached to said second ends of said filter cartridges and matably engaging said open end of said filter housing when said filter cartridge is placed within said filter housing in order to form a sealed pressure vessel;
a plurality of control ports in said manifold providing ingress for impure tap water into said manifold, and egress for treated product water and waste water away from said manifold; and
a plurality of fluid flow pathways being defined in said manifold for conveying said tap water to and from said control ports and housing inlet and outlet ports, and for conveying treated water to and from said various filter housings within said system;

2. The water treatment system of claim 1, wherein said system further comprises a water storage tank connected to said manifold for storing reverse osmosis filtered water prior to it being dispensed for use.

3. The water treatment system of claim 2, wherein said filter housings are unitarily formed with said manifold.

4. The water treatment system of claim 2, wherein said manifold comprises an upper manifold and a lower manifold.

5. The water treatment system of claim 4, wherein said filter housings are integrally molded into a top surface of said upper manifold.

6. The water treatment system of claim 4, wherein said lower manifold includes a first portion of each of said fluid flow pathways and said upper manifold includes a remaining portion of each of said fluid flow pathways, wherein said first portion and said remaining portion of said fluid flow pathways form complete fluid flow pathways when said upper and lower manifolds are fixedly mated together.

7. The water treatment system of claim 6, wherein said first portion of each of said fluid flow pathways is adapted to accept a plurality of pathway modification gates to selectively seal off specific fluid flow pathways and prevent water from passing there through.

8. The water treatment system of claim 6, wherein said lower manifold includes a plurality of fluid flow configuration ports disposed in said first portion of said fluid flow pathways, adapted to be open or closed in order to selectively provide ingress and egress of water to and from said fluid flow pathways.

9. The water treatment system of claim 8, wherein said water storage tank is selectively mounted to said bottom surface of said lower manifold and wherein at least one of said fluid flow configuration ports is open and connected to a fluid flow port of said storage tank to allow water to flow there between.

10. The water treatment system of claim 4, wherein said upper manifold contains said filter housing inlet and outlet ports as well as said control ports.

11. The water treatment system of claim 4, wherein said upper manifold further includes a drain flow restrictor control port and a drain flow control valve for selectively changing a drain rate of said waste water, a shutoff diaphragm valve port, and a check valve port.

12. The water treatment system of claim 11, wherein said drain flow control valve is a barrel having multiple orifices disposed therein through which said waste water flows and wherein said drain barrel can be selectively rotated to change the size of said orifices from a completely open state to either a partially open state or a completely closed state.

13. The water treatment system of claim 4, wherein said upper and lower manifolds are fixedly joined together, forming a hermetic seal there between.

14. The water treatment system of claim 4, wherein said lower manifold is adapted to be fixedly joined to a lower manifold of an identical system in order to operate as a single system.

15. The water treatment system of claim 4, wherein said lower manifold is adapted to be fixedly joined to at least one additional accessory.

16. The water treatment system of claim 3, including filter housing extension modules connected to said filter housings for increasing the length of said filter housings.

17. The water treatment system of claim 3, wherein said filter housings are adapted to accept filter cartridges of various sizes.

18. The water treatment system of claim 17, wherein said filter housings have unitarily formed therein at least two differently sized brine seal housings surrounding said fluid-outlet ports, each of said brine seal housings having an open end for mating with a similarly sized filter cartridge brine seal attached to said first end of said filter cartridge.

19. The water treatment system of claim 1, wherein said water treatment system is a reverse osmosis water treatment system.

20. A filter cartridge for use in a water treatment system, said cartridge comprising:
a filter media portion, having a first end and a second end;
a fluid seal connector fixedly attached to said first end of said filter media portion; and
a filter housing cap fixedly connected to said second end of said filter media portion.

21. The filter cartridge of claim 20, wherein said filter media portion is a hollow tube adapted to allow fluid to pass through an outer axial surface thereof and into a hollow space therein, and wherein said tube contains a plurality of layers of filtration material wrapped around said outer axial surface.

22. The filter cartridge of claim 21, wherein said filtration material is at least partly comprised of a reverse osmosis membrane.

23. The filter cartridge of claim 21, wherein said filtration material is at least partly comprised of a sediment filtration material.

24. The filter cartridge of claim 21, wherein said filtration material is at least partly comprised of a charcoal filtration material.

25. The filter cartridge of claim 20, wherein said cap contains at least one o-ring seal seated around an outer periphery thereof for forming a liquid tight seal with said filter housing of said reverse osmosis water treating system.

26. The filter cartridge of claim 20, wherein said filter housing cap is secured to said open end of said filter housing by pinning said cap into said open end of said filter housing.

27. The filter cartridge of claim 26, wherein said cap contains a pin retention groove for accepting a retention pin to secure said cap in said open end of said filter housing

28. The filter cartridge of claim 20, wherein said filter housing cap is permanently mated to said second end of said filter media portion.

29. The filter cartridge of claim 20, wherein said filter housing cap has removal tool engagement holes disposed in an outer surface thereof.

30. A filter cartridge for use in a water treatment system, said cartridge comprising:
a filter media portion, having a first end and a second end;
a fluid seal connector fixedly attached to said first end of said filter media portion; and
a filter housing cap connected to said second end of said filter media portion,
wherein said cap includes at least one sidewall connected thereto which extends from said cap in the direction of said filter media portion.

31. A water storage tank system for use with a water treatment system comprising:
a tank for storing treated water;
at least one tank fluid flow port disposed in said tank to provide ingress and egress of said treated water into and out of said tank, and wherein said tank fluid flow port is connected to a fluid flow control port of said water treating system;
a sealed gas-pressurized bladder contained within said tank;
a plurality of integrated fasteners disposed in said outer surface of said storage tank for releasably mounting said tank to a plurality of accessories and in a plurality of configurations.

32. The water storage tank of claim 31, wherein said tank is mounted via said fasteners to said water treatment system so as to form a single unit.

33. The water storage tank of claim 31, wherein said tank further comprises a plurality of field removable tank legs attached to an outer surface of said storage tank via said integrated fasteners, wherein said legs may be selectively removed and remounted to said tank at a different location on said outer surface to change the resting orientation of said tank.

34. The water storage tank of claim 33, wherein said tank is a stand-alone satellite storage tank, separated from said water treatment system.

35. The water storage tank of claim 31, wherein said tank is adapted to be fastened to at least one additional identical storage tank via a plurality of universal mounting brackets and said fasteners, to increase the water storage capacity of said water treatment system, and wherein said tanks are capable of being oriented in a vertical or horizontal position relative to each other.

36. The water storage tank of claim 31, wherein said tank is adapted to be mounted to a separate structure via said universal mounting brackets and said fasteners, such that said structure and said tank are in either a horizontal or vertical orientation relative each other.
